(19) United States
(12) Patent Application Publication
(10) Pub. No.: US 2022/0198134 A1
(43) Pub. Date: Jun. 23, 2022

(54) INFORMATION PROCESSING APPARATUS AND NON-TRANSITORY COMPUTER READABLE MEDIUM STORING INFORMATION PROCESSING PROGRAM

(71) Applicant: FUJIFILM Business Innovation Corp., Tokyo (JP)

(72) Inventors: Miyuki IIZUKA, Kanagawa (JP); Ryoko HASHIMOTO, Kanagawa (JP)

(73) Assignee: FUJIFILM Business Innovation Corp., Tokyo (JP)

(21) Appl. No.: 17/325,234

(22) Filed: May 20, 2021

(30) Foreign Application Priority Data
Dec. 18, 2020 (JP) 2020-210537

(51) Int. Cl. G06F 40/186; G06F 40/114; G06F 16/93; G06F 40/106

(52) U.S. Cl. CPC G06F 40/186; G06F 40/106; G06F 16/93; G06F 40/114

(57) ABSTRACT

An information processing apparatus includes a processor configured to display a document having plural pages while applying a template, display a corresponding page each time an operation to switch the pages is received, and sequentially switch and display the template each time an operation to switch the template is received.

### CROSS-REFERENCE TO RELATED APPLICATIONS

This application is based on and claims priority under 35 USC 119 from Japanese Patent Application No. 2020-210537 filed Dec. 18, 2020.

### BACKGROUND

### (i) Technical Field

A technique of the present invention relates to an information processing apparatus and a non-transitory computer readable medium storing an information processing program.

### (ii) Related Art

In the related art, a technique for displaying images while applying a template is known.

JP2019-074872A discloses a display device including an image selection unit that selects an image to be processed, a storage unit that stores a plurality of templates including a disposition region where an image is disposed, a template selection unit that selects a first template and a second template from the plurality of templates based on the selected image, a disposition unit that disposes the selected image of the disposition region of the first template and disposes the selected image in the disposition region of the second template, and a display control unit that displays the first template after the disposition of the image and the second template after the disposition of the image on a display unit.

A technique that rearranges an order of a list of templates is also known.

JP1998-232917A discloses a list display device including a display unit that displays a list of a plurality of templates having a predetermined edition condition in compliance with an order, a selection unit that selects an optional template from among the templates displayed on the display unit, and a history information storage unit that stores the selection of the optional template, and the order is decided based on history information stored in the history information storage unit.

### SUMMARY

Aspect of non-limiting embodiments of the present disclosure relate to an information processing apparatus and a non-transitory computer readable medium storing an information processing program capable of, in a case of applying a template to a document having a plurality of pages and confirming a combination of the pages and the template, simplifying an operation to switch the template, compared to a case where a template is directly designated.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to display a document having a plurality of pages while applying a template, display a corresponding page each time an operation to switch the pages is received, and sequentially switch and display the template each time an operation to switch the template is received.

### BRIEF DESCRIPTION OF THE DRAWINGS

Exemplary embodiment(s) of the present invention will be described in detail based on the following figures, wherein:

FIG. 1 is a system configuration diagram of a signature request apparatus;

FIG. 2 is a block diagram showing the hardware configuration of a signature request apparatus according to an exemplary embodiment;

FIG. 3 is a flowchart showing a flow of electronic signature request processing of the signature request apparatus according to the exemplary embodiment;

FIG. 4 is a flowchart showing a flow of processing of rearranging templates of the signature request apparatus according to the exemplary embodiment;

FIG. 5 is an example showing set values of setting items of the templates in the exemplary embodiment;

FIG. 6 is an example showing comparison results of attributes and setting items in the exemplary embodiment;

FIG. 7 is an example showing comparison results of the attributes and the setting items in the exemplary embodiment;

FIG. 8 is a flowchart showing a flow of processing of switching among pages and templates of the signature request apparatus according to the exemplary embodiment;

FIG. 9 is a flowchart showing a flow of processing of applying a template to a document of the signature request apparatus according to the exemplary embodiment;

FIG. 10 is an example showing a display screen in the exemplary embodiment;

FIG. 11 is an example of display where a template is applied to a document in the exemplary embodiment;

FIG. 12 is an example of application of a template having one surface in the exemplary embodiment;

FIG. 13 is an example of application of a template having a plurality of surfaces and having an element only on one surface in the exemplary embodiment;

FIG. 14 is an example of application of a template having a plurality of surfaces in the exemplary embodiment;

FIG. 15 is an example of application of a template having a plurality of surfaces in the exemplary embodiment;

FIG. 16 is an example showing notification of an element in the exemplary embodiment; and

FIG. 17 is an example of application of a template having one surface in a modification example.

### DETAILED DESCRIPTION

Hereinafter, an example of an exemplary embodiment of the technique of the invention will be described referring to the drawings. In the respective drawings, identical or equivalent elements and portions are represented by identical reference numerals. The ratio of the dimensions in the respective drawings is exaggerated for convenience of description and is different from the actual ratio in some cases.

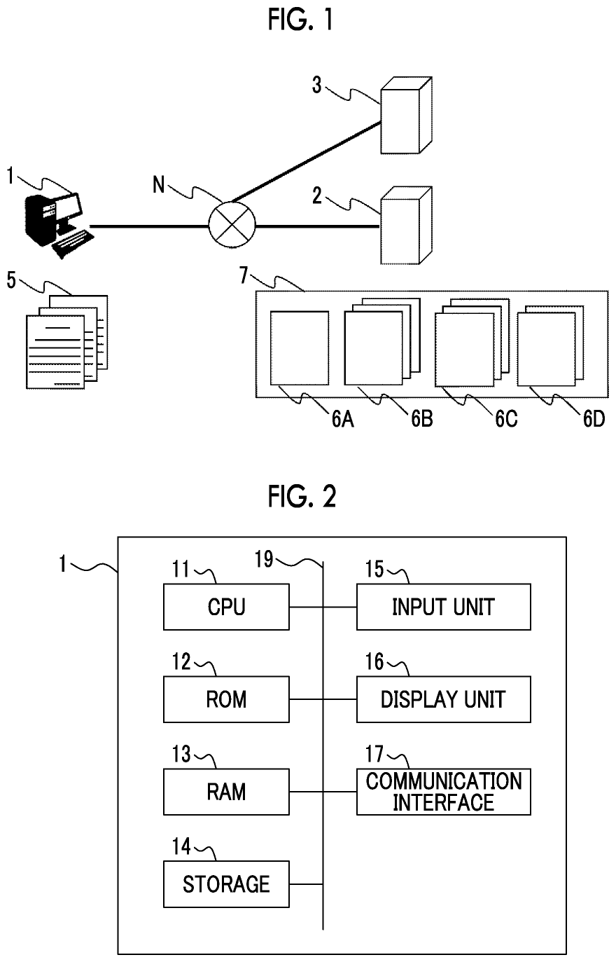

FIG. 1 is a system configuration diagram of a signature request apparatus 1 of the present disclosure. FIG. 1 shows a manner in which the signature request apparatus 1 as an example of an information processing apparatus acquires a template 6A, a template 6B, a template 6C, and a template 6D from a template server 2 through a network N. The signature request apparatus 1 may hold a document 5 that is a contract, in advance or may acquire the document 5 from an external server. The signature request apparatus 1 transmits E-mail to a mail server 3. In the following description, in a case where the templates are distinguished from one another, reference signs “A”, “B”, “C”, “D”, and “E” for distinguishing individuals are added, and in a case where the templates are not distinguished from one another, the description of the above-described reference signs are omitted.

The document 5 has one or a plurality of pages. The page includes at least one of text, a chart, and an image.

Each of the templates 6 gives a predefined element to a specific page of the document 5. In the example, each of the templates 6A to 6D is a template that gives a signature box 9 to be an input box as the predefined element. Each of the templates 6 has one or a plurality of surfaces.

The template server 2 holds one or more templates 6. The template server 2 transmits the templates 6 to the signature request apparatus 1 in response to a request of the signature request apparatus 1. The template server 2 may transmit a template list 7 to the signature request apparatus 1.

The template list 7 is a list having one or a plurality of templates 6. The signature request apparatus 1 arranges the templates 6 transmitted from the template server 2 to create the template list 7.

The mail server 3 receives E-mail transmitted from the signature request apparatus 1 and transfers E-mail to a transmission destination.

FIG. 2 is a block diagram showing the hardware configuration of the signature request apparatus 1 according to the exemplary embodiment. The signature request apparatus 1 has the respective configurations of a central processing unit (CPU) 11, a read only memory (ROM) 12, a random access memory (RAM) 13, a storage 14, an input unit 15, a display unit 16, and a communication interface (communication I/F) 17. The respective configurations are connected in a communicable manner through a bus 19.

The CPU 11 is a central processing unit and executes various programs or controls the respective units. That is, the CPU 11 reads a program from the ROM 12 or the storage 14 and executes the program with the RAM 13 as a work area. The CPU 11 performs the control of the respective configurations described above and various kinds of operation processing corresponding to the programs recorded in the ROM 12 or the storage 14. In the exemplary embodiment, an information processing program for electronic signature request processing is stored in the ROM 12 or the storage 14.

The ROM 12 stores various programs and various kinds of data. The RAM 13 temporarily stores a program or data as a work area. The storage 14 is constituted of a hard disk drive (HDD) or a solid state drive (SSD) and stores various programs including an operating system and various kinds of data.

The input unit 15 includes a pointing device, such as a mouse, and a keyboard, and is used to perform various inputs. The display unit 16 is, for example, a liquid crystal display, and displays various kinds of information. The display unit 16 may employ a touch panel system to function as the input unit 15.

The communication interface 17 is an interface for communication with other kinds of equipment, such as a database, and for example, the standard, such as Ethernet (Registered Trademark), FDDI, or Wi-Fi (Registered Trademark), is used.

Next, the operations of the signature request apparatus 1 will be described.

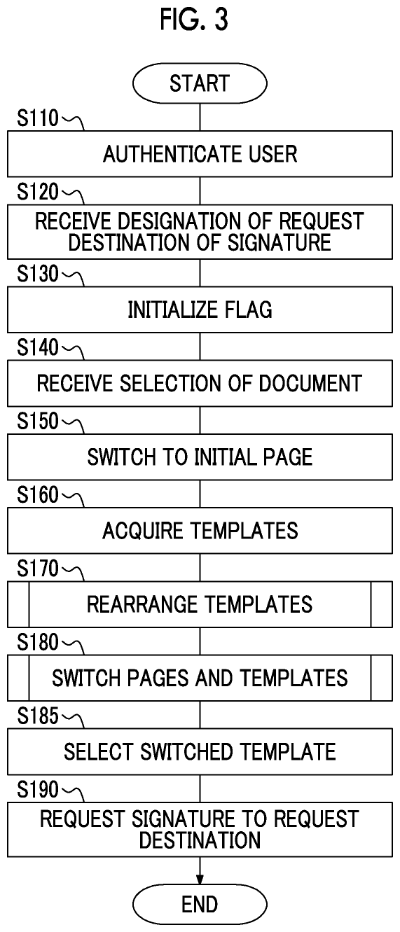

FIG. 3 is a flowchart showing a flow of the electronic signature request processing by the signature request apparatus 1 according to the exemplary embodiment. The CPU 11 reads an electronic signature request processing program from the ROM 12 or the storage 14, develops the electronic signature request processing program to the RAM 13, and executes the electronic signature request processing program, whereby the electronic signature request processing is executed.

In Step S110, the CPU 11 authenticates a user. Examples of authentication include authentication by a password, authentication by a token, biometrics authentication, and the like. In regard to authentication, the CPU 11 may request authentication to an external server.

In Step S120, the CPU 11 receives designation of a request destination of a signature. For example, the CPU 11 receives designation from a customer list registered in advance.

In Step S130, the CPU 11 initializes a flag. The flag is, for example, a bit having a value of 0 or 1. The initialization of the flag is turning off the flag. Turning off the flag is setting the value of the flag to 0, and turning on the flag is setting the value of the flag to 1.

In Step S140, the CPU 11 receives selection of the document 5.

In Step S150, the CPU 11 switches a page to an initial page. For example, the CPU 11 may set the initial page as a page 1 or may set a predetermined page as the initial page. For example, in a case where the document 5 is a contract, the CPU 11 may set the last page of the document 5 as the initial page. The contract has a signature space on the last page, and in a case where the user wants to apply a specific template 6 to the last page, user's labor for an operation to designate the last page can be saved.

In Step S160, the CPU 11 acquires the template 6. The CPU 11 acquires one or a plurality of templates 6 from the template server 2. The CPU 11 may acquire the template list 7 having a plurality of templates. The CPU 11 may acquire only a template related to the authenticated user from the template server 2.

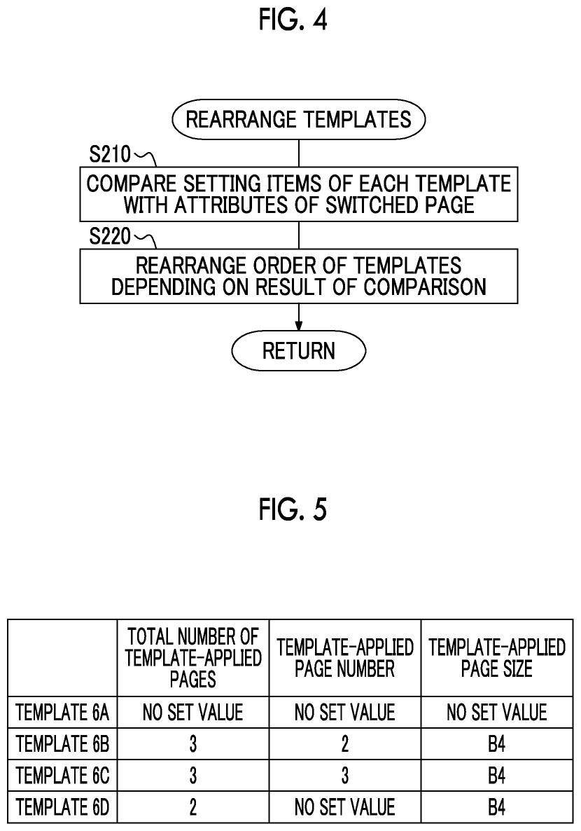

In Step S170, the CPU 11 rearranges the templates 6. Specific processing will be described below referring to FIG. 4.

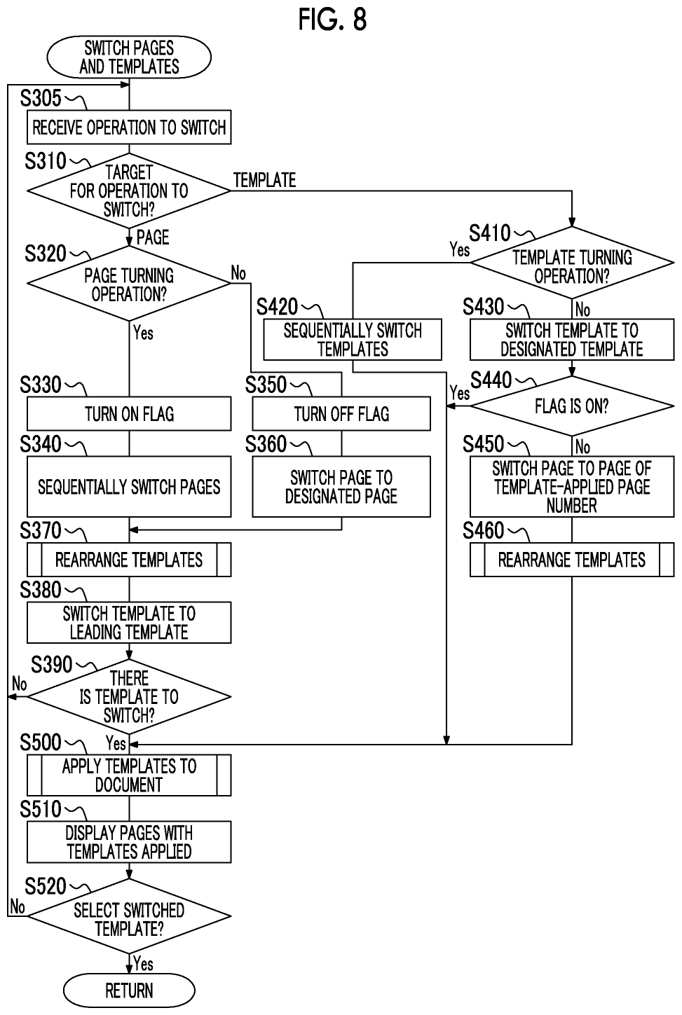

In Step S180, the CPU 11 switches among the pages and the templates 6. Specific processing will be described below referring to FIG. 8.

In Step S185, the CPU 11 selects the switched template 6.

In Step S190, the CPU 11 requests the signature to the request destination. For example, the CPU 11 transmits E-mail for requesting the signature to an E-mail address of the request destination.

FIG. 4 is a flowchart showing a flow of processing of rearranging the templates 6 by the signature request apparatus 1 according to the exemplary embodiment.

In Step S210, the CPU 11 compares setting items of each template with attributes of the switched page.

The setting items are items of which the values are set to the template, and include, for example, the total number of template-applied pages, a template-applied page number, and a template-applied page size. The total number of template-applied pages is the number of surfaces of the template 6, and in other words, is the total number of pages of the document 5 appropriate for the template 6. The template-applied page number is a page number of the document 5 to which the template 6 gives the predefined element, and in other words, is a page number of the document 5 corresponding to a surface having the element of the template 6. The template-applied page number may be set as, for example, a specific page number, such as a “page 2”, or maybe dynamically set to be a value equal to a last page number of the document 5, such as a “last page”. A plurality of page numbers, such as “pages 1, 3” may be set. The template-applied page size is a page size of the document 5 appropriate for the template 6. The template-applied page size maybe set to, for example, a predetermined page size, such as A4. Each setting item may be a necessary item or may be an optional item. A specific setting example will be described below referring to FIG. 5.

The attributes are the total number of pages, a page number of a displayed page, and a page size of the displayed page of the document 5.

The comparison of the setting items and the attributes is performed by comparison of the total number of template-applied pages and the total number of pages of the document 5, comparison of the template-applied page number of the page number of the displayed page, comparison of the template-applied page size and the page size of the displayed page, or a combination thereof.

In Step S220, the CPU 11 rearranges the order of the templates 6 depending on results of comparison. For example, the CPU 11 rearranges the templates 6 in a descending order of a total value of the number of coinciding setting items or a total value of scores obtained by weighting coinciding or non-coinciding setting items. For example, the CPU 11 rearranges the templates such that a template for which the page number of the displayed page is included in the template-applied page number is arranged higher than a template for which the page number is not included in the template-applied page number. Specific comparison processing will be described below referring to FIGS. 5, 6, and 7.

An example where a degree of coincidence of an attribute and a setting item is calculated will be described referring to FIGS. 5, 6, and 7.

FIG. 5 shows an example of set values of the setting items of the templates 6 in the exemplary embodiment. FIG. 5 is a table where each template 6 is on the vertical axis and the setting items of the template 6 are on the horizontal axis. The set values of the total number of template-applied pages, the template-applied page number, and the template-applied page size of the template 6A are “no set value”, “no set value”, and “no set value” in order. Similarly, the set values regarding the template 6B are 3, 2, and B4, the set values regarding the template 6C are 3, 3, and B4, and the set values regarding the template 6D are 2, “no set value”, and B4. In a case where the set value is not set in the setting item or there is no setting item, “no set value” is set.

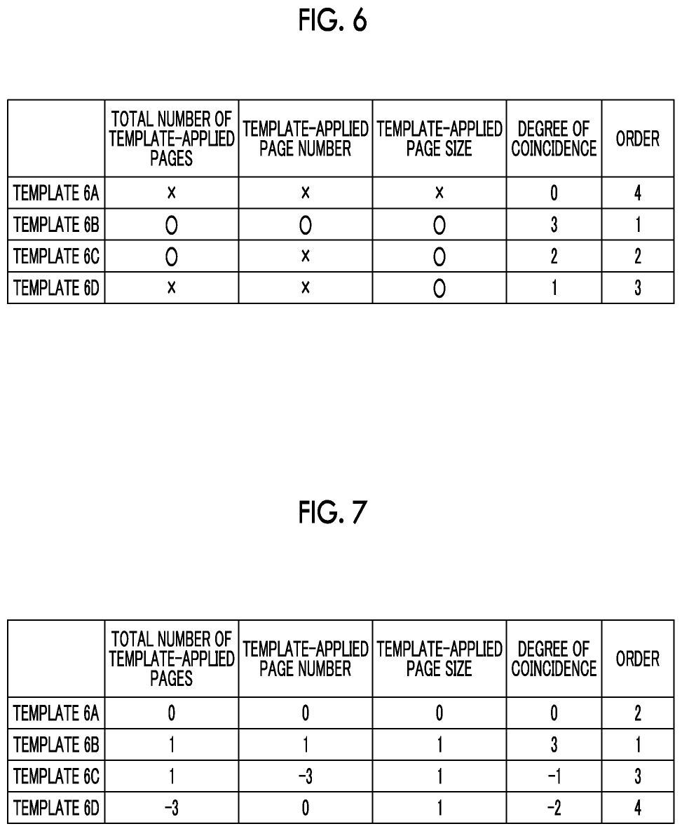

FIGS. 6 and 7 show an example of comparison results of the attributes and the setting items in the exemplary embodiment. FIGS. 6 and 7 show comparison results with the attributes that the total number of pages of the document 5 is 3, the page number of the displayed page is 2, and the page size of the displayed page is B4. FIGS. 6 and 7 are tables where each template 6 is on the vertical axis and the setting items of the template 6, a degree of coincidence, and an order are on the horizontal axis. Here, the degree of coincidence is the results of comparison of the attributes and the setting items, and a specific calculation method of the degree of coincidence will be described below referring to each of FIGS. 6 and 7. The calculation method of the degree of coincidence is not limited to the method described referring to FIG. 6 or 7. The order is an order in which the templates 6 are rearranged in a descending order of the calculated degree of coincidence. The template 6 of which the order is first is a leading template 6 of the template list 7.

In FIG. 6, the degree of coincidence is calculated by the number of coincidences of the attributes and the setting items. In FIG. 6, “◯” indicates coincidence, and “×” indicates non-coincidence. The comparison results of the total number of template-applied pages, the template-applied page number, and the template-applied page size of the template 6A are “non-coincidence”, “non-coincidence”, and “non-coincidence”, and the degree of coincidence is 0. Similarly, the comparison results regarding the template 6B are “coincidence”, “coincidence”, and “coincidence”, and the degree of coincidence is 3. The comparison results regarding the template 6C are “coincidence”, “non-coincidence”, and “coincidence”, and the degree of coincidence is 2. The comparison results regarding the template 6D are “non-coincidence”, “non-coincidence”, and “coincidence”, and the degree of coincidence is 1. An arrangement order of the templates 6 of the template list 7 is an order of the template 6B, the template 6C, the template 6D, and the template 6A in FIG. 6.

In FIG. 7, the degree of coincidence is calculated by adding one point in a case where the attribute and the setting item coincide with each other, subtracting three points in a case where the attribute and the setting item do not coincide with each other, not performing addition and subtraction of points in a case of “no set value”, and totaling the points. The comparison results of the total number of template-applied pages, the template-applied page number, and the template-applied page size of the template 6A are 0, 0, and 0 in order, and the degree of coincidence is 0. Similarly, the comparison results regarding the template 6B are 1, 1, and 1, and the degree of coincidence is 3. The comparison results regarding the template 6C are 1, −3, and 1, and the degree of coincidence is −1. The comparison results of the template 6D are −3, 0, and 1, and the degree of coincidence is −2. An arrangement order of the templates 6 of the template list 7 is an order of the template 6B, the template 6A, the template 6C, and the template 6D in FIG. 7. In the calculation method of the degree of coincidence, the points to be added are not limited to 1 and the points to be subtracted are not limited to 3. In the calculation method of the degree of coincidence, points may be added or subtracted in a case of “no set value”. The points to be added or subtracted may be determined for each setting item.

FIG. 8 is a flowchart showing a flow of processing of switching among the pages and the templates 6 by the signature request apparatus 1 according to the exemplary embodiment.

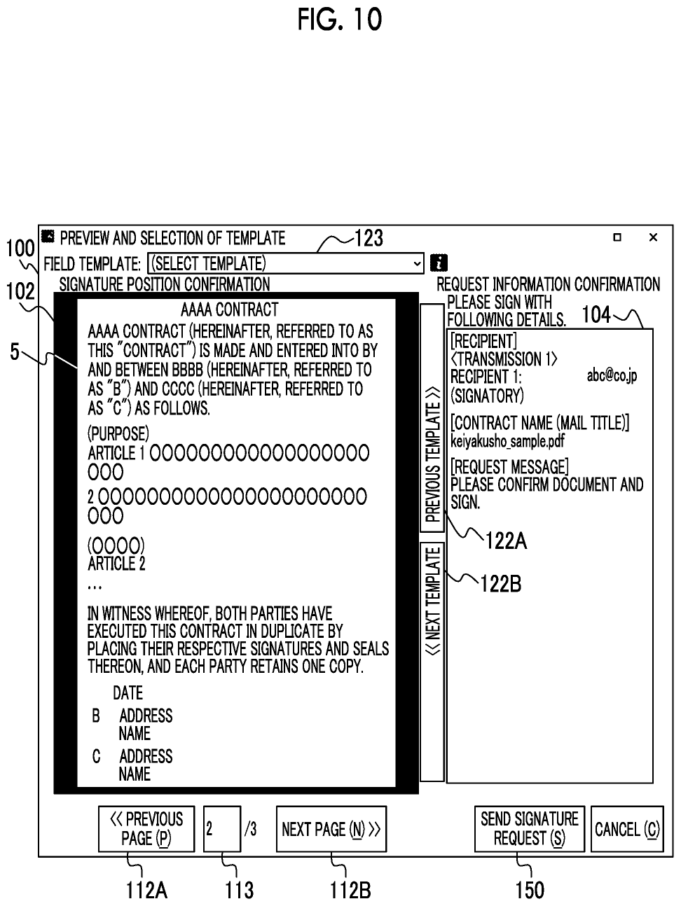

In Step S305, the CPU 11 receives an operation to switch. Here, the operation to switch is a page designation operation, a page turning operation, a template designation operation, and a template turning operation. The page designation operation is an operation to directly designate a page. The operation to directly designate a page is, for example, an operation to switch the page to a page of a designated page number. The page turning operation is an operation to sequentially switch the displayed page. Sequentially switching is switching the displayed page to a page previous or next to the displayed page. The template designation operation is an operation to directly designate the template 6. The operation to directly designate the template 6 is an operation to switch a template to a template specified by a name of the template. The template turning operation is switching the applied template to a previous template or a next template arranged in the template list 7. A specific example of the operation to switch will be described referring to FIG. 10.

In Step S310, the CPU 11 determines a target for the operation to switch. In a case where determination is made that the target for the operation to switch is a page (Step S310: page), the CPU 11 progresses to Step S320. In a case where determination is made that the target for the operation to switch is a template (Step S310: template), the CPU 11 progresses to Step S410.

In Step S320, the CPU 11 determines whether or not the operation to switch is the page turning operation. In a case where determination is made that the operation to switch is the page turning operation (Step S320: Yes), the CPU 11 progresses to Step S330. Ina case where determination is made that the operation to switch is not the page turning operation (Step S320: No), the CPU 11 progresses to Step S350.

In Step S330, the CPU 11 turns on the flag.

In Step S340, the CPU 11 sequentially switches among the pages. Sequentially switching among the pages is switching the displayed page to a previous page or a next page. For example, in a case where the displayed page is a page 2, the CPU 11 switches the displayed page to a page 3.

In Step S350, the CPU 11 turns off the flag.

In Step S360, the CPU 11 switches the page to a designated page. For example, in a case where the page 2 is designated, the CPU 11 switches the displayed page to the page 2.

In Step S370, the CPU 11 rearranges the templates 6. Specific processing is identical to the processing of FIG. 4, and thus, description will not be repeated.

In Step S380, the CPU 11 switches the template to the leading template 6. The CPU 11 may omit Step S380. The CPU 11 may switch the template to the leading template 6 in a case where a specific condition is satisfied. The specific condition is, for example, that the degree of coincidence of the leading template 6 is 3 in the calculation method of the degree of coincidence described referring to FIG. 7.

In Step S390, the CPU 11 determines whether or not there is the template 6 to be switched. In a case where determination is made that there is the template 6 to be switched (Step S390: Yes), the CPU 11 progresses to Step S500. In a case where determination is made that there is no template 6 to be switched (Step S390: No), the CPU 11 progresses to Step S305. The fact that there is no template 6 to be switched means a state in which an operation to switch the template 6 is never received. That is, the fact that there is no template 6 to be switched means a case where determination is never made in Step S310 that the target for the operation to switch is the template 6.

In Step S410, the CPU 11 determines whether or not the operation to switch is the template turning operation. In a case where determination is made that the operation to switch is the template turning operation (Step S410: Yes), the CPU 11 progresses to Step S420. In a case where determination is made that the operation to switch is not the template turning operation (Step S410: No), the CPU 11 progresses to Step S430.

In Step S420, the CPU 11 sequentially switches the template 6. Sequentially switching the template 6 is switching the applied template to a previous template or a next template of the template list 7. For example, in a case where the order is the order shown in FIG. 7, and the applied template is the template 6A, the CPU 11 switches the applied template to the template 6C that is the next template 6. In a case where no template 6 is applied, the template is switched to the leading template 6.

In Step S430, the CPU 11 switches the template to a designated template 6. For example, in a case where the template 6B is designated, the CPU 11 switches a template to be applied to the template 6B.

In Step S440, the CPU 11 determines whether or not the flag is on. In a case where the determination is made that the flag is off (Step S440: No), the CPU 11 progresses to Step S450. In a case where determination is made that the flag is on (Step S440: Yes), the CPU 11 progresses to Step S500.

In Step S450, the CPU 11 switches the page to a page of a template-applied page number. For example, in a case where the template to be switched is the template 6C, the template-applied page number is 3, and thus, the CPU 11 switches a page to be displyed to the page 3.

In Step S460, the CPU 11 rearranges the templates 6. Specific processing is identical to the processing of FIG. 4, and thus, description will not be repeated.

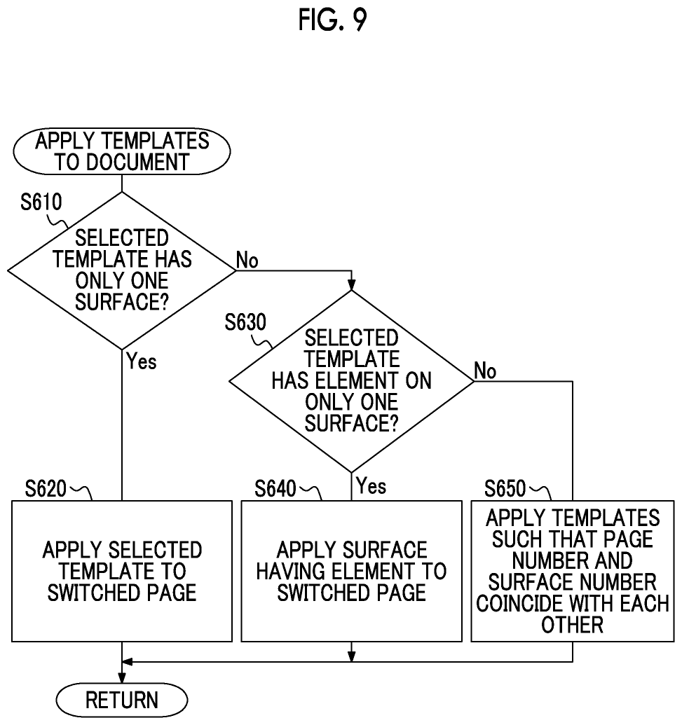

In Step S500, the CPU 11 applies the templates 6 to the document 5. Specific processing will be described below referring to FIG. 9.

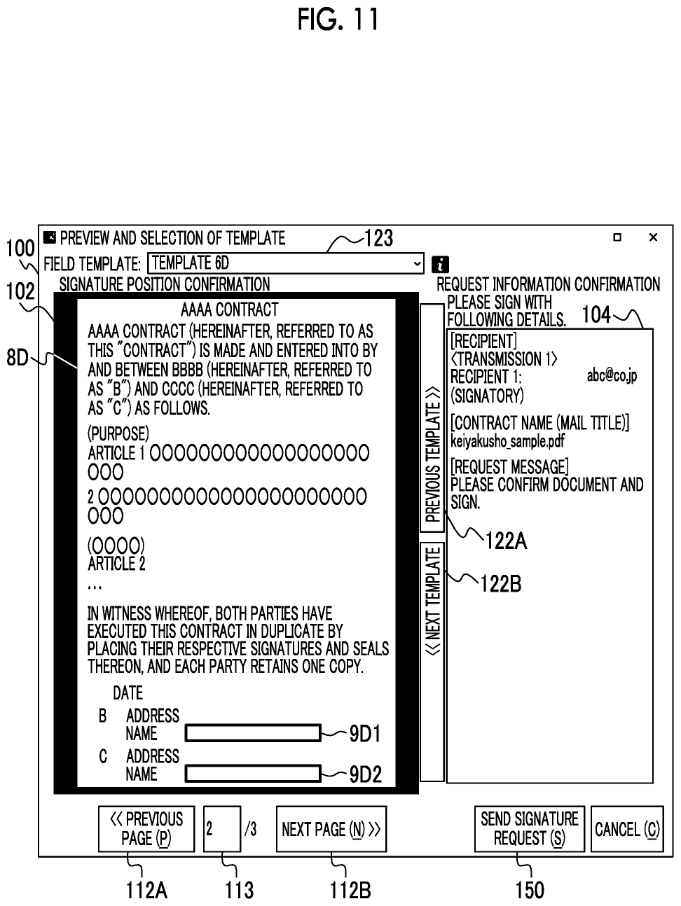

In Step S510, the CPU 11 displays the page with the template 6 applied. A specific example of the display will be described below referring to FIG. 11.

In Step S520, the CPU 11 determines whether or not to select the switched template 6. In a case where determination is made to select the switched template 6 (Step S520: Yes), the CPU 11 ends the processing of switching the pages and the templates 6. In a case where determination is made to not select the switched template 6 (Step S520: No), the CPU 11 progresses to Step S305. For example, the CPU 11 receives a user's operation to determine whether or not to select the template 6.

FIG. 9 is a flowchart showing a flow of processing of applying the template 6 to the document 5 by the signature request apparatus 1 according to the exemplary embodiment.

In Step S610, the CPU 11 determines whether or not the selected template 6 has only one surface. In a case where determination is made that the selected template 6 has only one surface (Step S610: Yes), the CPU 11 progresses to Step S620. In a case where determination is made that the selected template 6 does not have the only one surface (Step S610: No), the CPU 11 progresses to Step S630.

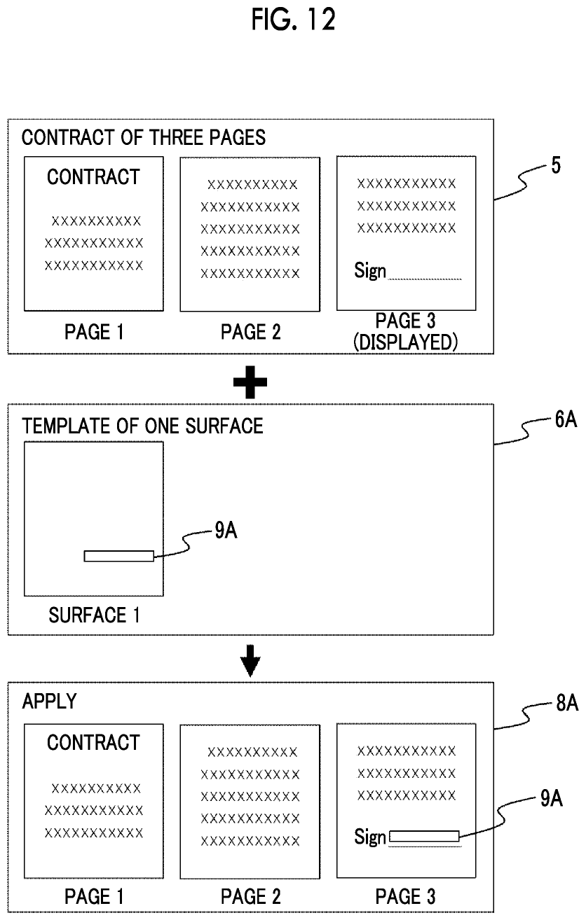

In Step S620, the CPU 11 applies the selected template 6 to the switched page. The CPU 11 ends the processing of applying the template 6 to the document 5. An application example will be described below referring to FIG. 12.

In Step S630, the CPU 11 determines whether or not the selected template 6 has an element on only one surface. In a case where determination is made that the selected template 6 has the element on only one surface (Step S630: Yes), the CPU 11 progresses to Step S640. In a case where determination is made that the selected template 6 has elements on a plurality of surfaces (Step S630: No) , the CPU 11 progresses to Step S650. The CPU 11 may omit Step S630 and may progress to Step S650.

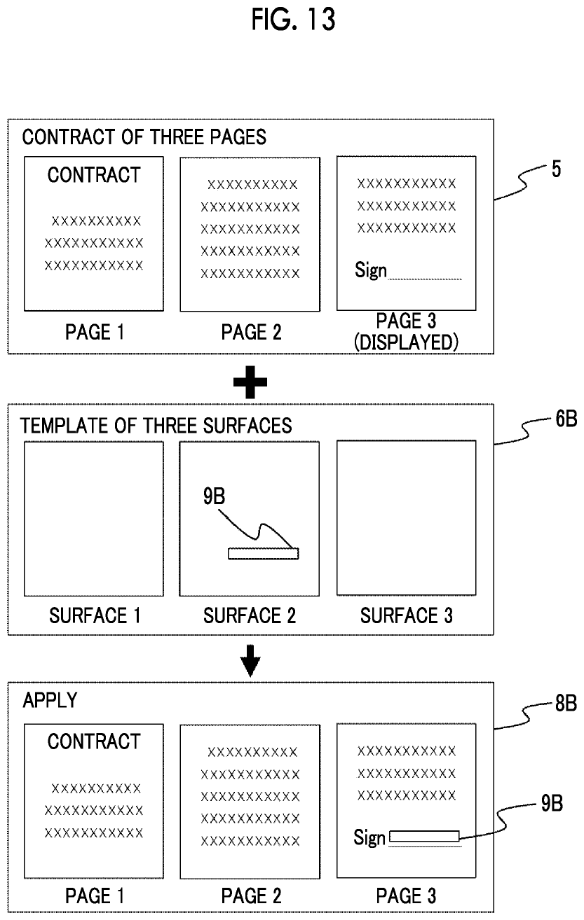

In Step S640, the CPU 11 applies the surface having the element to the switched page. An application example will be described referring to FIG. 13. The CPU 11 ends the processing of applying the template 6 to the document 5.

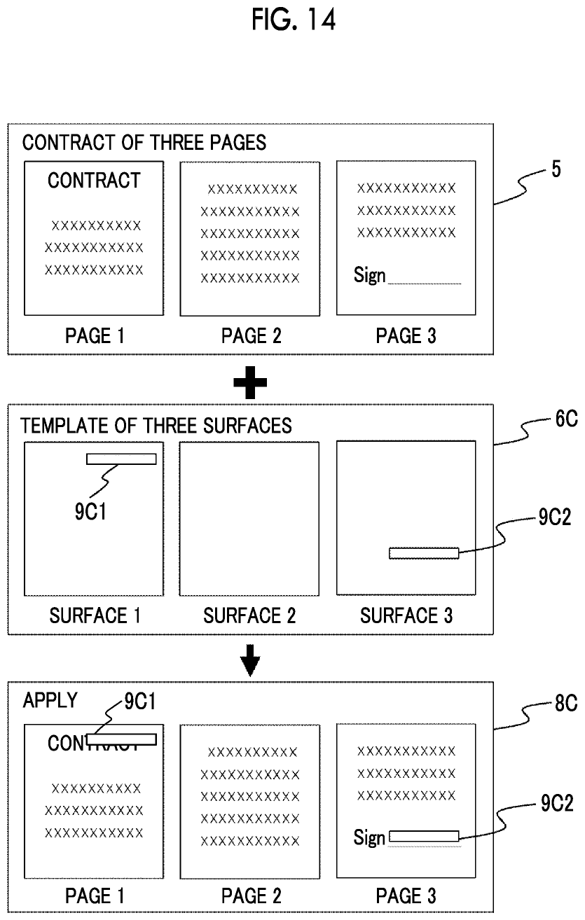

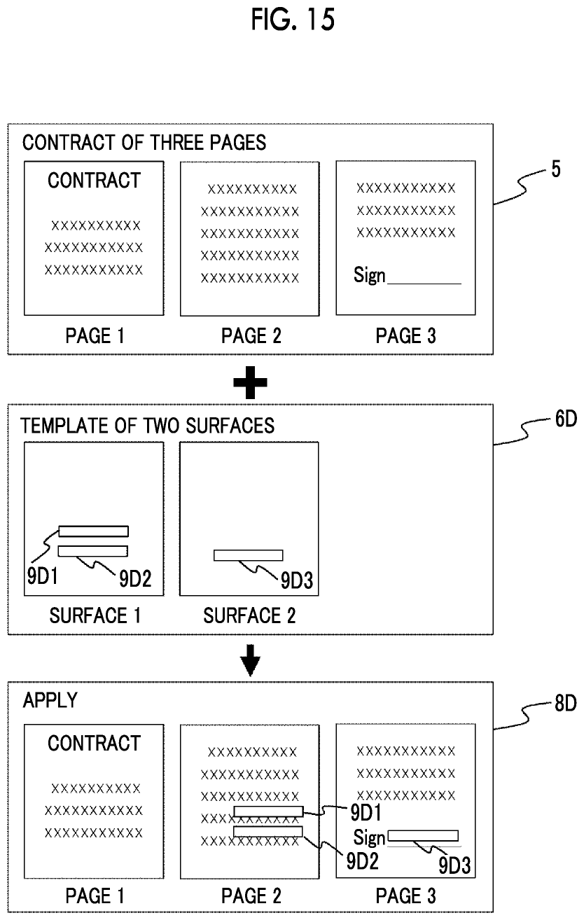

In Step S650, the CPU 11 applies the template 6 such that a page number and a surface number coincide with each other. An application example will be described referring to FIG. 14. For example, the CPU 11 may apply a specific surface of the template 6 to each of a plurality of pages. For example, the CPU 11 may apply the surfaces of the template 6 in a descending order of the surface number to the pages of the document 5 in a descending order of the page number one by one. An application Example will be described referring to FIG. 15. The CPU 11 ends the processing of applying the template 6 to the document 5.

FIGS. 10 and 11 are an example showing a display screen 100 in the exemplary embodiment. The display screen 100 has a preview region 102, a request information confirmation region 104, and various buttons and the like. In the following description, a lateral direction is a lateral direction on the display screen 100, and a longitudinal direction is a longitudinal direction on the display screen 100.

The preview region 102 is a region where a document 8 in which the template 6 is applied to the document 5 is displayed. In a case where the template 6 is not selected, the document 5 is displayed. In a case where the template 6 is selected, the document 8 with the template 6 applied is displayed. The preview region 102 may display each one page or may display a plurality of pages. In the following description, in a case where the documents 8 with the templates 6 applied are distinguished from one another, reference signs “A”, “B”, “C”, “D”, and “E” for distinguishing individuals are added, and in a case where the documents 8 are not distinguished from one another, the description of the above-described reference signs are omitted.

The request information confirmation region 104 displays request information of an electronic signature. The request information confirmation region 104 has, as items, a recipient item, a contract name item, and a request message item. In the recipient item, for example, the request destination of the signature designated in Step S120 is displayed. In the contract name item, a name of a contract is displayed. In the contract name item, for example, a file name of file data as the contract is displayed. The request message item is a message that is received by the request destination.

Various buttons and the like are a page turning button 112A, a page turning button 112B, a page designation input box 113, a template turning button 122A, a template turning button 122B, a template designation select box 123, and a request button 150. Various buttons and the like correspond to, for example, a click operation by a mouse as the input unit 15. In the following description, in a case where the page turning buttons and the template turning buttons are distinguished from each other, reference signs “A” and “B” for distinguishing individuals are added, and in a case where the page turning buttons and the template turning buttons are not distinguished from each other, the description of the above-described reference signs are omitted.

A click operation of the page turning button 112 executes the page turning operation of the document 5. That is, the click operation of the page turning button 112A is an operation to switch the displayed page to a previous page, and the click operation of the page turning button 112B is an operation to switch the displayed page to a next page. The click operation of the page turning button 112B switches the displayed page to the page 3, for example, in a case where the displayed page is the page 2. The page turning button 112A and the page turning button 112B may be disposed laterally, for example, below the preview region 102.

The page turning operation may be executed by a single operation other than the click operation. The single operation is one kind of operation. The single operation is, for example, a shortcut key operation, a scroll operation, a swipe operation, or a mouse gesture operation. The signature request apparatus 1 may be provided with a plurality of single operations.

For example, an operation to press a P key of a keyboard as the input unit 15 may execute an operation to sequentially switch the displayed page to the previous page. An operation to scroll to the left in the lateral direction by the mouse as the input unit 15 may execute an operation to sequentially switch the displayed page to the previous page. An operation to swipe to the left in the lateral direction by a touch panel as the display unit 16 may execute an operation to sequentially switch the displayed page to the previous page. An operation of a mouse gesture of drawing a circle may execute an operation to sequentially switch the displayed page to the previous page.

Similarly, for example, an operation to press an N key of the keyboard, an operation to scroll to the right in the lateral direction, and an operation to swipe to the right in the lateral direction may execute an operation to sequentially switch the displayed page to the next page.

The click operation also includes a double-click operation by the mouse. The shortcut key operation includes long press of a key and simultaneous press of a plurality of keys. The mouse gesture includes a combination of a plurality of mouse gestures. For example, a long press operation of the N key may sequentially switch the displayed page to the next page continuously.

An input operation of the page designation input box 113 executes a page designation operation of the document 5. The input operation means that a value is input to the input box. That is, the input operation of the page designation input box 113 performs an operation to switch the page to a page of a page number of the input value. The input operation of the page designation input box 113 switches the page to the page 2, for example, in a case where 2 is input.

A click operation of the template turning button 122 executes the template turning operation. That is, the click operation of the template turning button 122 executes an operation to sequentially switch the template 6 from the template list 7. The click operation of the template turning button 122A is an operation to switch the applied template to the previous template 6, and the click operation of the template turning button 122B is an operation to switch the applied template to the next template 6. For example, in a case where the template list 7 has an order of the template 6A and the template 6B, and the template 6A is applied, the click operation of the template turning button 122B switches a template to be applied to the template 6B. The template turning button 122A and the template turning button 122B may be disposed longitudinally on the right side of the preview region 102.

The template turning operation may be executed by a single operation other than the click operation.

For example, an operation to press a U key of the keyboard as the input unit 15 may execute an operation to sequentially switch the applied template to the previous template 6. An operation to scroll up in the longitudinal direction by the mouse as the input unit 15 may execute an operation to sequentially switch the applied template to the previous template 6. An operation to swipe up in the longitudinal direction by the touch panel as the display unit 16 may execute an operation to sequentially switch the applied template to the previous template 6.

Similarly, an operation to press a D key of the keyboard, an operation to scroll down in the longitudinal direction, and an operation to swipe down in the longitudinal direction may execute an operation to sequentially switch the applied template to the next template 6.

A click operation of the template designation select box 123 executes the template designation operation. That is, the click operation of the template designation select box 123 is an operation to designate a template directly from a pull-down menu to switch the template. For example, the click operation of the template designation select box 123 displays the list of templates in the arrangement order of the template list 7 to switch the applied template to the selected template 6. The operation to directly designate the template 6 may be a type of designating the template 6 from list display of thumbnails of the templates 6 or a type of inputting the name of the template 6, instead of the template designation select box 123.

The page turning buttons 112 and the template turning buttons 122 may be replaced with each other. For example, the page turning buttons 112 may be disposed on the right side of the preview region 102, and the template turning buttons 122 may be disposed below the preview region 102.

Similarly, the single operation corresponding to the page turning operation and the single operation corresponding to the template turning operation may be replaced with each other. For example, the scroll operation in the longitudinal direction may correspond to the page turning operation, and the scroll operation in the lateral direction may correspond to the template turning operation.

The single operation may be associated with a first direction or a second direction that is a direction different from the first direction. For example, the operation to swipe to the right may be an operation to sequentially switch the applied template to the previous page. Here, the operations to click the page turning button 112 and the template turning button 122 are examples of the operations associated with the first direction and the second direction, respectively. The longitudinal direction and the lateral direction are an example of the first direction or the second direction. That is, the first direction and the second direction may be directions other than the lateral direction and the longitudinal direction.

The request button 150 is a button for requesting a signature to a recipient. A click operation of the request button 150 transmits a request message to, for example, an E-mail address of the recipient. E-mail is transmitted to the mail server 3.

FIG. 11 is an example of display where the template 6 is applied to the document 5 in the exemplary embodiment. FIG. 11 displays a document 8D in which the template 6D is applied to the document 5. The template 6 has, as the element of the template 6, a signature box 9 that is one or a plurality of input boxes and coordinates thereof. For example, the template 6D has a signature box 9D1 and a signature box 9D2.

In the following description, in a case where the signature boxes are distinguished from one another, reference signs “A”, “B”, “C1”, “C2”, “D1”, “D2”, and “D3” for distinguishing individuals are added, and in a case where the signature boxes are not distinguished from one another, the description of the above-described reference signs are omitted.

FIG. 12 is an example where the template 6 having one surface is applied in the exemplary embodiment. FIG. 12 shows a manner in which the template 6A is applied to the document 5 and a document 8A with the template 6A applied is generated. The signature request apparatus 1 displays a page 3 of the document 5. The template 6A is the template 6 having one surface and has a signature box 9A. In a case where the template 6A is applied to the document 5, the signature request apparatus 1 displays the displayed page while applying the template 6. That is, the signature request apparatus 1 displays the signature box 9A on a page 3 in a superimposed manner.

FIG. 13 is an example where the template 6 having a plurality of surfaces and having an element on only one surface is applied in the exemplary embodiment. FIG. 13 shows a manner in which the template 6B is applied to the document 5 and a document 8B with the template 6B applied is generated. The signature request apparatus 1 displays a page 3 of the document 5. The template 6B is the template 6 having three surfaces, has a signature box 9B on a surface 2, and does not have an element on a surface 1 and a surface 3. In a case where the template 6B is applied to the document 5, the signature request apparatus 1 displays the displayed page while applying the surface having the element. That is, the signature request apparatus 1 displays the signature box 9B on a page 3 in a superimposed manner.

FIG. 14 is an example where the template 6 having a plurality of surfaces is applied in the exemplary embodiment. FIG. 14 shows a manner in which the template 6C is applied to the document 5 and a document 8C with the template 6C applied is generated. The template 6C is the template 6 having three surfaces, has a signature box 9C1 on a surface 1, and has a signature box 9C2 on a surface 3. In a case where the template 6C is applied to the document 5, the signature request apparatus 1 displays the page while applying the template 6C such that the surface number and the page number coincide with each other. That is, the signature request apparatus 1 displays the signature box 9C1 on a page 1 in a superimposed manner, and displays the signature box 9C2 on a page 3 in a superimposed manner.

FIG. 15 is an example where the template 6 having a plurality of surfaces is applied in the exemplary embodiment. FIG. 15 shows a manner in which the template 6D is applied to the document 5 and a document 8D with the template 6D applied is generated. The template 6D is the template 6 having two surfaces, has a signature box 9D1 and a signature box 9D2 on a surface 1, and has a signature box 9D3 on a surface 2. In a case where the template 6D is applied to the document 5, the signature request apparatus 1 displays the pages of the document 5 while applying the surfaces of the template 6 in a descending order of the surface number to the pages of the document 5 in a descending order of the page number one by one. That is, the signature request apparatus 1 displays the signature box 9D1 and the signature box 9D2 on a page 2 in a superimposed manner, and displays the signature box 9D3 on a page 3 in a superimposed manner. This is because the contract tends to be provided with a signature place in a latter part, and the signature place and the position of the signature box 9 may coincide with each other by application in a descending order.

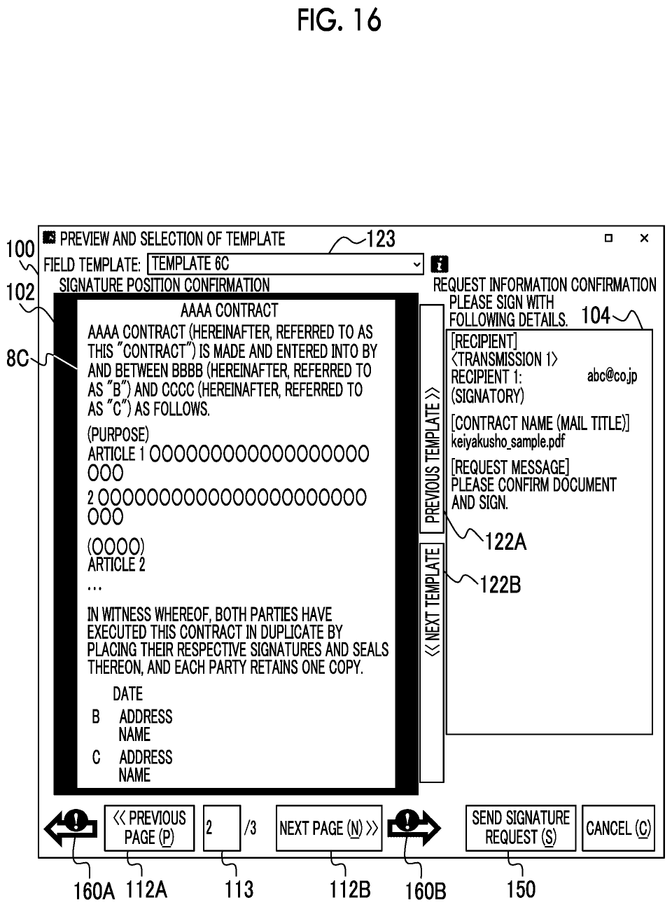

FIG. 16 is an example showing notification of an element in the exemplary embodiment. In a case where there is the element of the template 6 on a non-displayed page, the signature request apparatus 1 displays a notification icon for notifying a user of the effect. In FIG. 16, similarly to FIG. 14, the template 6C is applied to the document 5. The signature request apparatus 1 displays the page 2 of the document 5. As described above referring to FIG. 14, there are the signature boxes 9 as the element of the template 6 on the page 1 and the page 3. In this case, the signature request apparatus 1 displays a notification icon 160A for notifying that there is the signature box 9C1 on the page 1. The signature request apparatus 1 also displays a notification icon 160B for notifying that there is the signature box 9C2 on the page 3. In the following description, in a case where the notification icons are distinguished from each other, reference signs “A” and “B” for distinguishing individuals are added, and in a case where the notification icons are not distinguished from each other, the description of the above-described reference signs are omitted.

A click operation of the notification icon 160 switches the displayed page to a page to which a template having an element is applied. For example, in a case where the notification icon 160A is clicked, the signature request apparatus 1 displays the page 1 on which there is the signature box 9C1.

The click operation of the notification icon 160 may correspond to a shortcut key operation, a scroll operation, or a swipe operation. For example, the signature request apparatus 1 creates a list in which only surfaces having elements among the surfaces of the applied template are arranged. Then, the displayed page is switched to a page to which a surface previous or next to a surface applied to the displayed page, by a click operation or the like. An operation to switch only a page to which a surface having an element is applied may be an operation different from an operation to switch a page. In FIG. 16, the click operation of each of the notification icon 160A and the notification icon 160B is the operation to switch only a page to which a surface having an element is applied. The operation to switch only a page to which a surface having an element is applied may be associated with a direction identical to the direction with which the operation to switch a page is associated. For example, in a case where the operation to switch a page corresponds to an operation to swipe to the right in the lateral direction, the signature request apparatus 1 may correspond a swipe operation associated with the notification icon 160 to an operation to swipe to the right in the lateral direction by two fingers.

### MODIFICATION EXAMPLE

The signature request apparatus 1 of the exemplary embodiment has been described above. Note that the present disclosure is not limited to the above-described exemplary embodiment. Various improvements or alterations can be made.

In Steps S120 and S190 of FIG. 3, the request destination and the signature box 9 may be associated with each other. In Step S120, the CPU 11 receives designation of request destinations of a plurality of signatures. In Step S190, the CPU 11 requests signatures to the request destinations in an order of signature boxes. for example, in a case where the template 6C is selected, the CPU 11 sets a first request destination to the signature box 9C1, and sets a second request destination to the signature box 9C2. Then, the CPU 11 transmits E-mail to the first request destination. Next, the CPU 11 confirms that there is the signature of the first request destination in the signature box 9C1, and then, transmits E-mail to the second request destination.

In Step S170 of FIG. 3, the CPU 11 may rearrange the templates in a descending order of the degree of coincidence of the total number of pages or the page size of the document and the total number of template-applied pages or the template-applied page size of the template or the combinations thereof.

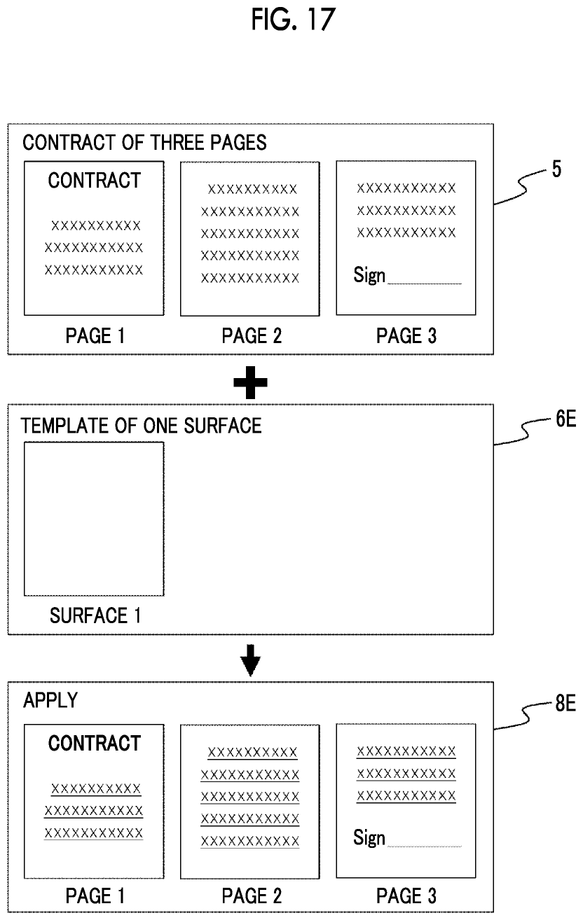

The template 6 may be the template 6 that gives, as the predefined element, an element other than an input box. For example, the template 6 may give an attribute of predetermined text, a figure, or a character. The attribute of the character is, for example, font, size, bold, italic, or underline. A template 6E that gives an attribute of a character will be described referring to FIG. 17.

FIG. 17 is an example where the template 6E having one surface is applied in the modification example. FIG. 17 shows a manner in which the template 6E is applied to the document 5 and a document 8E with the template 6E applied is generated. The template 6E is the template 6 that has one surface, and is the template 6E that shows a title in bold and gives underlines to text. The signature request apparatus 1 may apply the surface 1 to all pages. In the document 8E with the template 6E applied, “contract” as the title is shown in bold, and text is underlined.

The above-described processing can also be realized by a dedicated hardware circuit. In this case, the above-described processing may be executed by one piece of hardware or may be executed by a plurality of pieces of hardware.

In the exemplary embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

A program for operating the signature request apparatus 1 may be provided by a computer readable recording medium, such as a universal serial bus (USB) memory, a flexible disk, or a compact disc read only memory (CD-ROM), or may be provided online through a network, such as the Internet. In this case, the program recorded in the computer readable recording medium is typically transferred to and stored in a memory, a storage, or the like. The program may be provided, for example, as single application software or may be incorporated, as one function of the signature request apparatus 1, in software of each apparatus.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to display a document having a plurality of pages while applying a template, display a corresponding page each time an operation to switch the pages is received, and sequentially switch and display the template each time an operation to switch the template is received.

2. The information processing apparatus according to claim 1,
wherein the operation to switch the template is a single operation.

3. The information processing apparatus according to claim 1,
wherein the operation to switch the template is an operation associated with a first direction, and
the operation to switch the pages is an operation associated with a second direction that is a direction different from the first direction.

4. The information processing apparatus according to claim 2,
wherein the operation to switch the template is an operation associated with a first direction, and
the operation to switch the pages is an operation associated with a second direction that is a direction different from the first direction.

5. The information processing apparatus according to claim 3,
wherein the first direction is a longitudinal direction or a lateral direction, and
the second direction is a direction different from the first direction between the longitudinal direction and the lateral direction.

6. The information processing apparatus according to claim 4,
wherein the first direction is a longitudinal direction or a lateral direction, and
the second direction is a direction different from the first direction between the longitudinal direction and the lateral direction.

7. The information processing apparatus according to claim 3,
wherein the processor is configured to, in a case where the template is a template having a plurality of surfaces, displays each of the plurality of pages while applying a specific surface of the template, and sequentially switch and display only a page to which a surface having an element is applied, among the plurality of pages by an operation different from the operation to switch the pages.

8. The information processing apparatus according to claim 4,
wherein the processor is configured to, in a case where the template is a template having a plurality of surfaces, display each of the plurality of pages while applying a specific surface of the template, and sequentially switch and display only a page to which a surface having an element is applied, among the plurality of pages by an operation different from the operation to switch the pages.

9. The information processing apparatus according to claim 5,
wherein the processor is configured to, in a case where the template is a template having a plurality of surfaces, displays each of the plurality of pages while applying a specific surface of the template, and sequentially switch and display only a page to which a surface having an element is applied, among the plurality of pages by an operation different from the operation to switch the pages.

10. The information processing apparatus according to claim 6,
wherein the processor is configured to, in a case where the template is a template having a plurality of surfaces, displays each of the plurality of pages while applying a specific surface of the template, and sequentially switch and display only a page to which a surface having an element is applied, among the plurality of pages by an operation different from the operation to switch the pages.

11. The information processing apparatus according to claim 7,
wherein the processor is configured to sequentially switch and display only the surface having the element among the surfaces of the applied template by an operation that is different from the operation to switch the pages and is associated with the second direction.

12. The information processing apparatus according to claim 8,
wherein the processor is configured to sequentially switch and display only the surface having the element among the surfaces of the applied template by an operation that is different from the operation to switch the pages and is associated with the second direction.

13. The information processing apparatus according to claim 1,
wherein the processor is configured to, in a case where the template is a template having a plurality of surfaces, display each of the plurality of pages while applying a specific surface of the template, and in a case where there is an element that is applied to a non-displayed page, notify that there is the element on the non-displayed page.

14. The information processing apparatus according to claim 1,
wherein the processor is configured to, in a case where the template has only one surface having an element, display the displayed page while applying the surface having the element.

15. The information processing apparatus according to claim 1,
wherein the template has one or more setting items among the total number of template-applied pages and a template-applied page size, and
the processor is configured to rearrange templates in a descending order of a degree of coincidence of attributes including the total number of pages and a page size of the document, and the setting items.

16. The information processing apparatus according to claim 15,
wherein the setting items further include a template-applied page number, and
the processor is configured to, in a case where the pages are switched, rearrange the templates in a descending order of a degree of coincidence of attributes including the total number of pages, a page number of a displayed page, and a page size of the displayed page of the document, and the setting items.

17. The information processing apparatus according to claim 1,
wherein the template has a setting item of a template-applied page number, and
the processor is configured to, in a case where the pages are switched, rearrange templates such that a template for which a page number of a displayed page is included in the template-applied page number is arranged higher than a template for which the page number is not included in the template-applied page number.

18. The information processing apparatus according to claim 15,
wherein the processor is configured to, in a case where the templates are rearranged, display the page while applying a leading template.

19. The information processing apparatus according to claim 1,
wherein the template has a setting item of a template-applied page number, and
the processor is configured to, in a case where designation of a template is received, display a page corresponding to the template-applied page number while applying the designated template.

20. A non-transitory computer readable medium storing an information processing program that causes a computer to execute processing of
displaying a document having a plurality of pages while applying a template,
displaying a corresponding page each time an operation to switch the pages is received, and
sequentially switching and displaying the template each time an operation to switch the template is received.
